(19) United States
(12) Patent Application Publication
(10) Pub. No.: US 2005/0182678 A1
(43) Pub. Date: Aug. 18, 2005

(54) Products and processes for vending machine gift certificates

(76) Inventors: Jay S. Walker, Ridgefield, CT (US); Daniel E. Tedesco, Huntington, CT (US); Paul T. Breitenbach, Wilton, CT (US); Robert C. Tedesco, Fairfield, CT (US); James A. Jorasch, New York, NY (US); Michael D. Downs, Stamford, CT (US)

Correspondence Address: WALKER DIGITAL, FIVE HIGH RIDGE PARK, STAMFORD, CT, 06905, US

(21) Appl. No.: 11/057,904

(22) Filed: Feb. 14, 2005

Related U.S. Application Data
(60) Provisional application No. 60/544,086, filed on Feb. 12, 2004.

(51) Int. Cl. G06F 17/60

(52) U.S. Cl. 705/14

(57) ABSTRACT

An embodiment of the invention includes outputting, from a vending machine, an inactive voucher which includes a voucher identifier. A request to activate the voucher and a payment are received. An amount of payment is determined based on the voucher identifier, and at least the amount of payment is received. The voucher is activated, and then a request to redeem the voucher is received. A gift that corresponds to the voucher is determined, and the gift is provided via the vending machine.

The present application claims the benefit of priority of U.S. provisional Patent Application No. 60/544,086, entitled “Apparatus, Systems and Methods for Issuing and Redeeming Vending Machine Gift Certificates”, filed on Feb. 12, 2004, the entirety of which is incorporated herein by reference.

### BRIEF DESCRIPTION OF THE DRAWINGS

FIG. 1 depicts an example of a system according to an embodiment of the invention.

FIG. 2 depicts an example of a voucher database according to an embodiment of the invention.

FIG. 3 depicts an example of an activation process according to an embodiment of the invention.

FIG. 4 depicts an example of a redemption process according to an embodiment of the invention.

FIG. 5 depicts an example of a gift voucher according to an embodiment of the invention.

FIG. 6 depicts another example of a gift voucher according to an embodiment of the invention.

FIG. 7 depicts an example of an inactive sample voucher according to an embodiment of the invention.

### DETAILED DESCRIPTION

In the following description, reference is made to the accompanying drawings that form a part of the present disclosure, and in which are shown, by way of illustration, specific embodiments of the invention. These embodiments are described in sufficient detail to enable those skilled in the art to practice the invention, and it is to be understood that other embodiments may be utilized and that structural, logical, software, electrical and other changes may be made without departing from the scope of the present invention. The present disclosure is, therefore, not to be taken in a limiting sense. The present disclosure is neither a literal description of all embodiments of the invention nor a listing of features of the invention which must be present in all embodiments.

Numerous embodiments are described in this patent application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with various modifications and alterations. Although particular features of the present invention may be described with reference to one or more particular embodiments or figures, it should be understood that such features are not limited to usage in the one or more particular embodiments or figures with reference to which they are described.

The terms “an embodiment”, “embodiment”, “embodiments”, “the embodiment”, “the embodiments”, “an embodiment”, “some embodiments”, and “one embodiment” mean “one or more (but not all) embodiments of the present invention(s)” unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The enumerated listing of items does not imply that any or all of the items are mutually exclusive. The enumerated listing of items does not imply that any or all of the items are collectively exhaustive of anything, unless expressly specified otherwise. The enumerated listing of items does not imply that the items are ordered in any manner according to the order in which they are enumerated.

The terms “a”, “an” and “the” mean “one or more”, unless expressly specified otherwise.

The methods described herein (regardless of whether they are referred to as methods, processes, algorithms, calculations, and the like) inherently include one or more steps. Therefore, all references to a “step” or “steps” of such a method have antecedent basis in the mere recitation of the term ‘method’ or a like term. Accordingly, any reference in a claim to a ‘step’ or ‘steps’ of a method is deemed to have sufficient antecedent basis.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are illustrative arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, other formats (including relational databases, object-based models and/or distributed databases) could be used to store and manipulate the data types described herein. Likewise, object methods or behaviors of a database can be used to implement the processes of the present invention. In addition, the databases may, in a known manner, be stored locally or remotely from a device which accesses data in such a database.

### DEFINITIONS

The following terms are defined as indicated below, unless explicitly described otherwise:

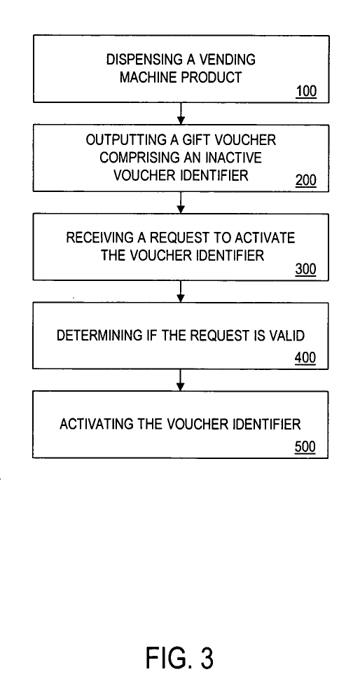

Activation Process, Activation Routine, Activation Sequence—A series of steps that result in the activation of a voucher identifier and a corresponding gift voucher, thereby permitting the voucher to be redeemed (possibly subject to other constraints such as the voucher's expiration). FIG. 3 illustrates an embodiment of an activation process. In some embodiments, an activation process requires input from a gift giver. An activation process may include, in some embodiments, the steps of
(i) receiving a request to activate a voucher identifier,
(ii) determining if the request is valid, and/or
(iii) activating the voucher identifier.

Thus, in some embodiments, a voucher identifier and its corresponding gift voucher may be considered inactive before an activation process is complete, and active upon completion of the activation process.

Fill Period, Sales Period—The period of time between restock dates of a vending machine. Typically, the fill period of a given vending machine does not vary significantly or at all.

Gift, Gift Product, Corresponding Gift—A benefit which is or which may be provided to a gift recipient upon the redemption of a valid voucher. In various embodiments, a gift can comprise (i) a vending machine credit (e.g., $1.00 redeemable toward any vending machine purchase); (ii) one or more vending machine products, such as a specific product (e.g., a Snickers® bar); (iii) a product selected from a particular category or inventory group (e.g., any one bag of a chip product, any item in the “green” group), and/or (iv) a discount applicable to any of the foregoing (e.g., get any $1 product for ten cents, get a Snickers® bar for half price, get any one bag of a chip product for twenty five cents).

Gift Giver, Gift Purchaser, Customer, First Customer—An entity that provides a corresponding gift voucher to a recipient. A gift giver may also activate the voucher (e.g., by depositing adequate payment and entering an activation code).

Gift Recipient, Recipient, Second Customer—An entity that receives a gift voucher. In some embodiments, a gift recipient is entitled to redeem a gift voucher at a vending machine for one or more benefits, including products, discounts, and the like.

Gift Voucher, Gift Certificate, Voucher—A token (e.g., a small piece of paper dispensed from a vending machine, plastic or paper cards comprising magnetic strips or barcodes) that (if valid) can enable a recipient to redeem a gift from one or more vending machines. A gift voucher may comprise or be associated with a voucher identifier used to uniquely identify that voucher.

Operator—The owner of a vending machine (or agent thereof).

Product, Item—A good or service provided (e.g., sold) by a vending machine or via a vending machine. Examples of goods sold at vending machines include beverages (e.g., cans of soda) and snacks (e.g., candy bars). Examples of services sold by vending machines include photography services and access to digital content (e.g., providing wireless Internet access, providing wireless telephone service, permitting the downloading of MP3 files to a portable device such as a handheld MP3 player, permitting or facilitating the downloading of digital “ring tone” or other files to a cellular telephone). Products redeemed by gift recipients upon the presentment of valid gift certificates may be referred to as gift products or corresponding gifts.

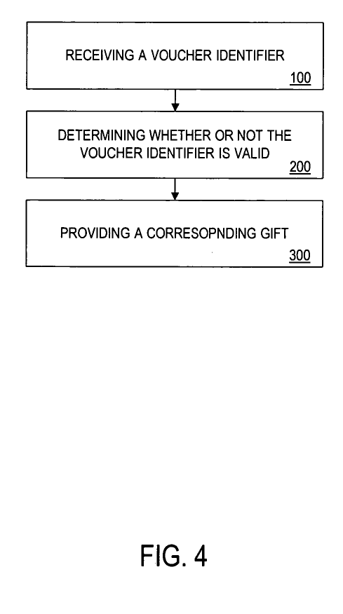

Redemption Process, Redemption Routine—A series of steps that result in the provision of a corresponding gift of a voucher. FIG. 4 illustrates an embodiment of a redemption process. In some embodiments, a redemption process requires input from a gift recipient. A redemption process may include, in some embodiments, the steps of
(i) receiving a voucher identifier,
(ii) determining whether or not the voucher is valid, and/or
(iii) providing a corresponding gift.

Restock Date, Restock Time—The time and/or date that a vending machine is scheduled to be restocked by an operator of a vending machine. Typically, a restock date follows the end of a fill period.

Voucher Identifier—A code (e.g., a series of numeric or alphanumeric digits, a glyph) or other means that identifies a particular gift voucher or its terms (e.g., the code ‘1827953’ corresponds to a unique gift voucher entitling the bearer to “Pick any $0.75 snack”).

### EXAMPLES OF CERTAIN EMBODIMENTS

Immediately below are examples of certain embodiments of the invention. These examples are provided for purposes of illustration only, and do not limit the scope of the invention described herein.

### First Example

Mark and Jesse live on the same floor of a college dormitory, and are both big sports fans. As Mark is from New York and Jesse from Dallas, they constantly tease each other about which of their favorite professional football teams is better. The big weekend came when the two teams finally faced each other, and Mark's team defeated Jesse's team handily.

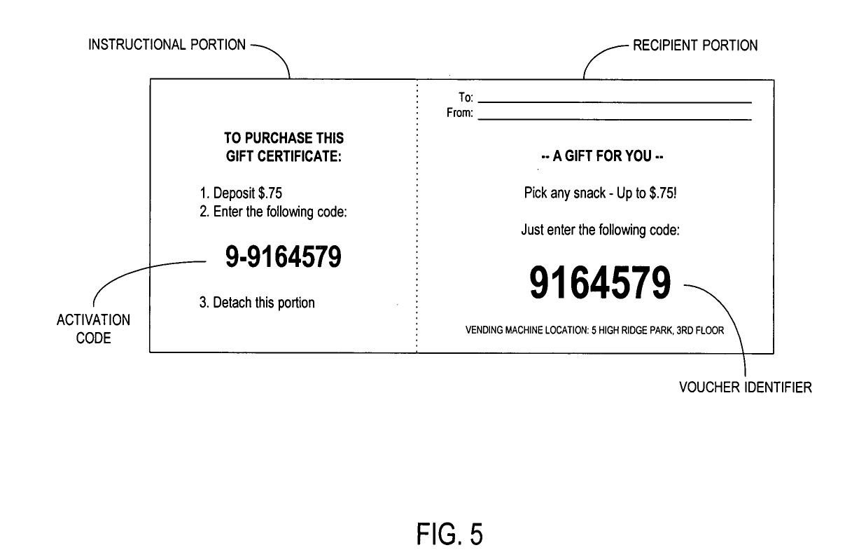

Meanwhile, Mark had been buying snacks from the vending machine near the elevator for a few months. He noticed that every time he bought one, the machine printed out a gift certificate (an example of which is depicted in FIG. 5). Each certificate was a small piece of paper with a perforation dividing it into two sections. One section simply read, “A gift for you—Pick any snack up to $0.75! Just enter code 9164579.” The other section, which could be easily torn from the first section, contained instructions for activating the gift certificate (“To purchase this gift certificate, insert $0.75 and enter code 9-9164579”).

The night of the victory, Mark was walking by the vending machine and thought, since Jesse likes candy, it might be a funny idea to give him some as a consolation prize for his team's loss. Besides, he wanted a bag of Doritos® for himself. He bought his Doritos®, and as he expected, the machine printed out an inactive gift certificate. Mark followed the activation procedure to activate the gift certificate by depositing $0.75 and entering 9-9164579 using the vending machine's keypad. He then tore away the instructional portion, and made his way toward Jesse's room. He tossed the gift certificate on Jesse's desk and said, “Hey Jesse, maybe next time your team won't lose so badly. Have a some candy on me.” Jesse and Mark shared a good laugh.

The next day on the way to class, Jesse took the gift certificate out of his wallet and entered the redemption code (i.e., voucher identifier) on the vending machine's keypad. The credit balance of the vending machine was increased from zero to $0.75, and Jesse selected a Milky Way® bar.

### Second Example

For a number of years, Alice and Rodney had worked as business reporters for the same newspaper. Frequently, when writing stories in the newsroom together, Alice would joke that Rodney couldn't seem to drink enough Dr. Pepper®, which he bought regularly from the beverage vending machine in the lobby.

When Alice was informed of Rodney's promotion to an editorial position, she thought it would be a great idea to give him a small congratulatory gift. She thought to herself, “The new vending machine in the lobby sells gift certificates. I think I'll get him a few sodas next time I'm down there.”

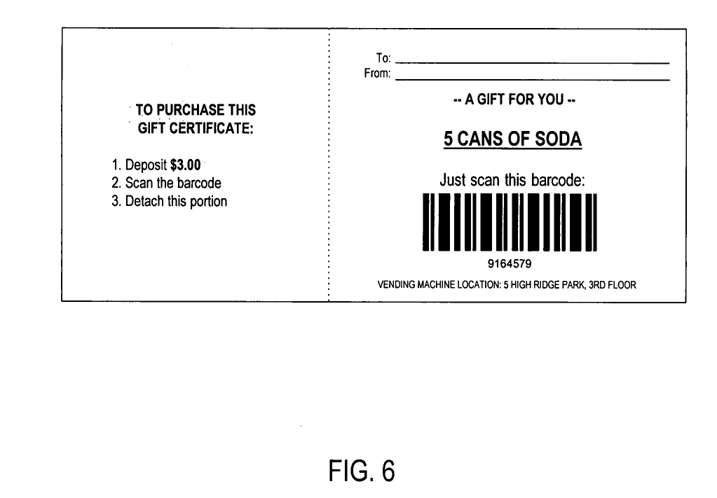

Later that day, Alice visited the vending machine to purchase a gift certificate enabling Rodney to purchase several cans of soda. When she approached the machine, an inactive “5 Cans of Soda” gift certificate could already be seen dangling from the printer (see, e.g., FIG. 6), such that a passerby might easily tear it off or view it. She removed the inactive gift certificate and, by pressing a clearly labeled button on a touch-sensitive display screen, indicated that she'd like to purchase it. She deposited the required $3, following the prompts on the display screen. Before completing her purchase of the gift certificate, Alice was able to key-in a message that Rodney would see when redeeming his sodas. Using the touch-screen, she entered: “We all know how much you love Dr. Pepper. Have a few on me. Congratulations!”

Alice left the gift certificate on Rodney's desk, filling out a blank “To/From” section using a pen. Rodney, delighted to discover the gift, immediately went to the lobby to get a soda or two. He placed the gift certificate, which had a barcode printed on it, under an infrared scanner clearly labeled “Scan your gift certificate here!” The display screen indicated to Rodney that he could redeem five sodas at any time, and could select his first now.

Rodney used the gift certificate several times throughout the week to purchase cans of Dr. Pepper®, noting that the display screen indicated his remaining balance each time. He chuckled each time he read Alice's message.

Machine Casing/Cabinetry

In some embodiments, suitable machine cabinetry may be constructed from any combination of (1) commercial grade (e.g. sixteen-gauge) steel (e.g., for exterior panels and internal shelving), (2) transparent materials such as glass or Plexiglas (e.g., for item display windows), (3) rubber (e.g., for waterproofing insulation), (4) plastic, (5) aluminum, and/or (6) any suitable material.

Many commercially available machine casings can be modified to work in accordance with the present invention. For example, in snack machine embodiments, a suitable machine casing may comprise the 129 SnackShop manufactured by Automatic Products International, Ltd. Of Saint Paul, Minn., which stands at 72″/1829 mm wide, has a width of 38 ⅞″/988 mm, and a depth of 35″/889 mm. Other suitable snack machine casings include the A La Carte® machine from Automatic Products, and the GPL SnackVendor model #159 from Crane Merchandising Systems/Crane Co. of Stamford, Conn.

In beverage machine embodiments, machine casings such as those commercially available from Dixie Narco, Inc. of Williston, S.C. may be employed. Beverage machine casings may comprise a “cooler” or “glass front” style front panel, featuring a transparent front panel (e.g., glass) enabling customers to see inventory for sale. Alternatively, beverage machine casings may comprise a “bubble front” style front panel, featuring a decorative front panel, typically used to advertise a logo of a product manufacturer commercially interested in the vending machine's operation.

Other embodiments are contemplated as well, including combination snack and beverage vending machine embodiments, such as those available from Crain Co. Further details concerning the suitability of machine casing/cabinetry are well known in the art, and need not be described in further detail herein.

Inventory Storage and Dispensing Mechanisms

Inventory storage and distribution functions of a vending machine configured in accordance with a snack machine embodiment of the present invention may include one or more of: (i) a drive motor, (ii) metal shelves, (iii) a product delivery system (e.g., a chute, product tray, product tray door, etc.), (iv) dual spiral (i.e. double helix) item dispensing rods, (v) convertible (i.e. extendable) shelves, and/or (vi) a refrigeration unit. In embodiments using the casing of the model 129 SnackShop manufactured by Automatic Products, 3 removable shelves may be employed, together providing for 30 product rows and an inventory capacity of between 185 to 522 commonly vended snack products.

Inventory storage and distribution functions of a vending machine configured in accordance with a beverage machine embodiment of the present invention may include one or more of: (i) metal and/or plastic shelving, (ii) item dispensing actuators/motors, (iii) product delivery chutes, and/or (iv) a refrigeration unit.

Further details concerning vending machine inventory storage and dispensing mechanisms are well known in the art, and need not be described in further detail herein.

Payment Processing Mechanisms

The vending machine may also include one or more mechanisms for receiving payment and dispensing change, including a coin acceptor, a bill validator, a card reader (e.g., a magnetic stripe reader) and a change dispenser.

In a manner known in the art, a magnetic stripe card reader may read data on the magnetic stripe of a credit or debit card, and it may cooperate with conventional point-of-sale credit card processing equipment to validate card-based purchases through a conventional transaction authorization network. Suitable card-based transaction processing systems and methods are available from USA Technologies, Inc.

The coin acceptor, bill validator and change dispenser may communicate with a currency storage apparatus (a “hopper”) and may comprise conventional devices such as models AE-2400, MC5000, TRC200 by Mars, Inc. of West Chester, Pa., or CoinCo model 9300-L. The coin acceptor and bill validator may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled COIN TUBE MONITOR MEANS, the entirety of which is incorporated by reference herein. The change dispenser activates the return of coinage to the customer where appropriate (e.g., where a customer rejects or otherwise fails to accept a dynamically priced upsell offer). Such apparatus may feature Multidrop Bus (MDB) and/or Micromech peripheral capabilities, as is known in the art.

In another embodiment, a vending machine in accordance with the present invention may be configured to receive payment authorization and product selection commands through a wireless device communication network, directly or indirectly, from a customer's wireless device (e.g., a cellular telephone). In such an embodiment, a payment processing mechanism may comprise a cellular transceiver operatively connected to a processor, as described herein. Exemplary systems and methods allowing for the selection of and payment for vending machine articles through cellular telephones are provided by USA Technologies, Inc., of Wayne, Pa. Further, in some embodiments, a customer's cellular telephone may serve as an input/output device, as described herein.

Further details concerning vending machine payment processing mechanisms are well known in the art.

Input/Output Devices

In accordance with embodiments of the present invention, a vending machine may include one or more input devices that are operable to receive input from (i) a first customer pursuant to a conventional vending machine transaction and/or a gift certificate activation process, (ii) a second customer pursuant to a gift redemption process, and/or (iii) an operator (or agent thereof) during stocking or maintenance of the vending machine. Also, a vending machine may include one or more output devices that are operable to output product information and/or offer information (e.g., gift certificate status information) to a customer or operator.

Many combinations of input devices and output devices may be employed in accordance with the present invention. In some embodiments, a vending machine may include more than one input device. For example, a vending machine may include an exterior input device for receiving customer input and an interior input device for receiving operator input. In some embodiments, however, the input device provides the dual functionality of receiving input data from both operators and customers. Likewise, a vending machine may comprise more than one output device (e.g., an LCD screen and several LEDs, as described herein). However, in some embodiments (such as those which feature touch screens), input and output functionality may be provided by a single device.

Many input devices are contemplated. Thus, an input device may comprise one or more of the following: (i) a set of alpha-numeric keys for providing input to the vending machine, such as the Programmable Master Menu® Keypad, (ii) a selector dial, (iii) a set of buttons associated with a respective set of item dispensers, (iv) a motion sensor, (v) a barcode reader (e.g., a 1-D or 2-D barcode reader), (vi) a voice recognition module, (vii) a Dual-Tone Multi-Frequency receiver/decoder, (viii) a wireless device (e.g., a cellular telephone or wireless Personal Digital Assistant), (ix) a radio-frequency identification receiver, (x) a smart card reader, (xi) a magnetic stripe reader, and (xii) any other conventional input device commonly employed by a vending machine designer.

In some embodiments, a vending machine may comprise an input device (e.g., a sensor which detects radio frequency electromagnetic signals of within a certain frequency range, a signal transceiver) operable to receive a signal (e.g., a 0.6 Watt radio frequency electromagnetic signal between 824 and 850 MHz, an infrared signal) from a cellular phone or other handheld device. In one embodiment, a vending machine input device comprises an optical reader (e.g., a 2-D bar code scanner) capable of scanning a barcode, such as a bar code which is displayed on a screen or monitor of a user's cellular phone, PDA, Blackberry business phone, Blackberry handheld or other handheld device. One system employing such technology, the Cmode service, has been developed by a partnership between Coca-Cola Co. and NTT DoCoMo Inc. of Japan.

Likewise, many types of output devices are contemplated. For example, an output device may comprise a Liquid Crystal Display (LCD). Alternatively or additionally, an output device may also comprise one or more Light Emitting Diode (LED) displays (e.g., several alphanumeric LED displays on the shelves of a vending machine, each LED display associated proximately with a row of product inventory).

In one embodiment, an LED display screen is mounted atop the vending machine (via bolts or other known mounting hardware) and may be used, e.g., to communicate offers and other messages (e.g., product advertisements) to prospective customers. A suitable LED display screen for such an embodiment may be housed in an aluminum case having a length of 27.5″, a height of 4.25″, and a depth of 1.75″. Such a display screen may have a display area capable of showing 13 alphanumeric and/or graphical characters. Further, such an LED display screen may comprise a serial computer interface, such as an RJ45/RS232 connector, for communicating with a processor, as described herein. Further still, such an LED display may be capable of outputting text and graphics in several colors (e.g., red, yellow, green, black), and such text may involve, e.g., current and upcoming gift certificate promotions.

Further, in some embodiments, an output device comprises a printer. In one embodiment, a printer is configured to print on card stock paper (e.g., 0.06 mm to 0.15 mm thickness), such as the EPSON EU-T400 Series Kiosk Printer. Further, a printer may be capable of thermal line printing of various alphanumeric and graphical symbols in various font sizes (e.g., ranging from 9 to 24 point) on various types of paper. Additionally, such a printer may communicate with a processor (described herein) via an RS232/IEEE 12834 and/or bi-directional parallel connection. Such a printer may further comprise a 4 KB data buffer.

Additionally, in some embodiments, an output device comprises an audio module, such as an audio speaker, that outputs information to customers audibly. As is known, such speakers may be used to produce prerecorded and/or synthesized sounds which may be stored as computer files in a variety of formats (e.g., .wav files, .mp3 files, .wma files).

In some embodiments, a touch-sensitive screen may be employed to perform both input and output functions. Suitable, commercially available touch screens for use in accordance with various embodiments are manufactured by Elo TouchSystems, Inc., of Fremont, Calif., such as Elo's AccuTouch series touch screens. Such touch screens may comprise: (i) a first (e.g., outer-most) hard-surface screen layer coated with an anti-glare finish, (ii) a second screen layer coated with a transparent-conductive coating, (iii) a third screen layer comprising a glass substrate with a uniform-conductive coating. Further, such touch screens may be configured to detect input within a determined positional accuracy, such as a standard deviation of error less than ±0.080-inch (2 mm). The sensitivity resolution of such touch screens may be more than 100,000 touchpoints/in² (15,500 touchpoints/cm²) for a 13-inch touch screen. For such touch screens, the touch activation force required to trigger an input signal to the processor (described herein) via the touch screen is typically 2 to 4 ounces (57 to 113 g). Additionally, touch screens for use in accordance with the present invention may be resistant to environmental stressors such as water, humidity, chemicals, electrostatic energy, and the like. These and other operational details of touch screens (e.g., drive current, signal current, capacitance, open circuit resistance, closed circuit resistance, etc.) are well known in the art.

Further, an input/output device may comprise a substrate dispenser, such as a card dispenser or ticket dispenser. Such a dispenser may comprise means for dispensing tickets as well as a sensor (e.g., barcode scanning technology) operable to read inserted tickets or gift vouchers (which may be inserted in a slot different than one from which tickets are dispensed). One such card dispenser, the CTD-200, is manufactured by Vendapin, LLC, of Dryden, N.Y.

Logic/Control/Processing Apparatus

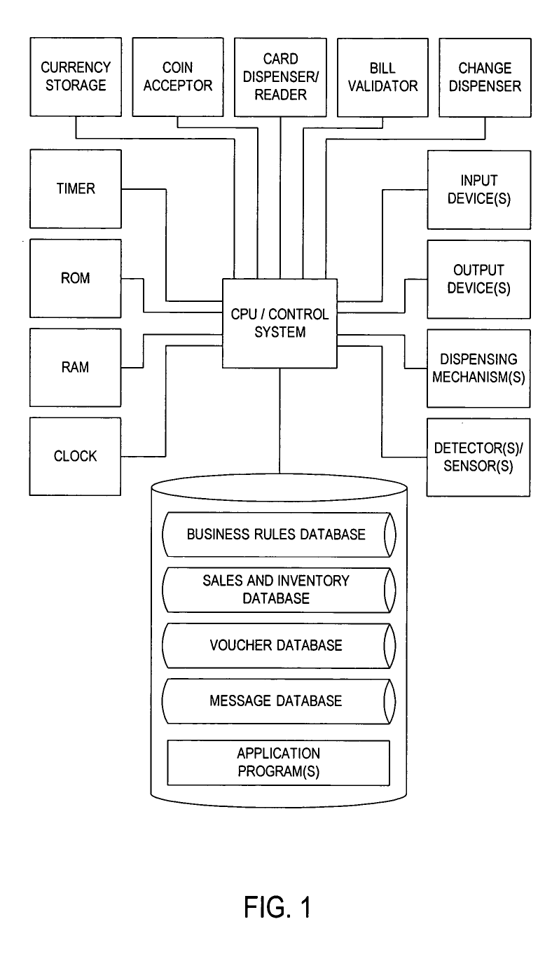

The components of the vending machine, including the input devices, output devices, coin acceptor, bill validator, card (e.g., magnetic stripe) reader, change dispenser, currency storage apparatus, and product dispensing mechanism(s) (collectively, the “peripherals”) communicate with, and are controlled by, a control system or processor, such as one based on the Intel® Pentium® series processor (FIG. 1 depicts an illustrative system overview). The processor may be in communication with a memory and a communications port (e.g., for communicating with one or more other computers, vending machines and the like). The memory may comprise an appropriate combination of magnetic, optical and/or semiconductor memory, and may include, for example, Random Access Memory (RAM), Read-Only Memory (ROM), a compact disc and/or a hard disk. The memory may comprise or include any type of computer-readable medium. The processor and the memory may each be, for example: (i) located entirely within a single computer or other device; or (ii) connected to each other by a remote communication medium, such as a serial port cable, telephone line or radio frequency transceiver.

A memory may store a program for controlling a processor. The processor performs instructions of the program, and thereby operates in accordance with the present invention, and particularly in accordance with the processes described in detail herein. The program may be stored in a compressed, uncompiled and/or encrypted format. The program furthermore includes program elements that may be necessary, such as an operating system, a database management system and “device drivers” for allowing the processor to interface with the peripherals. Appropriate program elements are known to those skilled in the art, and need not be described in detail herein.

According to an embodiment of the present invention, the instructions of the program may be read into a main memory from another computer-readable medium, such as from a ROM. The execution of sequences of the instructions in a program causes the processor to perform the process steps described herein. In alternate embodiments, hard-wired circuitry may be used in place of, or in combination with, software instructions for implementation of the processes of the present invention. Thus, one of ordinary skill in the art will readily recognize that embodiments of the present invention are not limited to any specific combination of hardware and software.

The memory also may store one or more databases. Some or all of the data stored in various illustrated databases are described herein.

Thus, the machine's processing apparatus, in conjunction with the peripherals (e.g., through RS232 connections and/or other suitable connections), manages interactions with the user in accordance with stored business logic, described herein.

Retrofitting Conventional Vending Machines with a Separate Device

In one embodiment, one or more of the processor, the input device(s), RAM, ROM, output device(s) and a data storage device may be included, wholly or partially, in a separate device, such as the e-Port™ by USA Technologies Inc., that is in communication with a vending machine. The separate device may also be in communication with a network such as the Internet.

The e-Port™ is a credit and smart card-accepting unit that controls access to office and MDB vending equipment, and serves as a point of purchase credit card transaction device. The e-Port™ includes an LCD that allows for the display of color graphics, and a touch sensitive input device (touch screen) that allows users to input data to the device. The display may be used to prompt users interactively with, e.g., offers and information about their transaction status.

The separate device may alternatively be a programmed computer running appropriate software for performing the necessary functions described herein. The separate device may be operable to receive input from customers, receive payment from customers, exchange information with a remotely located server and/or display messages to customers (e.g., gift messages, gift voucher offers). The separate device may be operable to instruct the vending machine that appropriate payment has been received (e.g., via a credit card read by the separate device) and/or that a particular product should be dispensed by the vending machine. Further, the separate device may be operable to instruct the vending machine to perform other functions, such as execute promotions, execute price changes, and/or dispense gift vouchers.

Thus, a separate device may be operatively connected to a vending machine to perform various processes described herein. In this manner, conventional vending machines may be retrofitted with such separate devices so as to perform the processes described herein.

### Network Embodiments

Embodiments of the present invention can be configured to work in a network environment including a computer that is in communication, via a communications network, with one or more vending machines. The computer may communicate with the vending machines directly or indirectly, via a wired or wireless medium such as the Internet, LAN, WAN or Ethernet, Token Ring, or via any appropriate communications means or combination of communications means. Each of the vending machines may comprise computers, such as those based on the Intel® Pentium® processor, that are adapted to communicate with the computer. Any number and type of machines may be in communication with the computer.

Communication between the vending machines and the computer, and among the vending machines, may be direct or indirect, such as over the Internet through a Web site maintained by computer on a remote server or over an on-line data network including commercial on-line service providers, bulletin board systems and the like. In yet other embodiments, the vending machines may communicate with one another and/or the computer over RF channels, cable TV channels, satellite links or other known communication means.

Some, but not all, possible communication networks that may comprise the network or be otherwise part of the system include: a local area network (LAN), a wide area network (WAN), the Internet, a telephone line, a cable line, a radio channel, an optical communications line, and a satellite communications link. Possible communications protocols that may be part of the system include: Ethernet (or IEEE 802.3), SAP, ATP, Bluetooth™, WIFI 802.11x, and TCP/IP. Communication may be encrypted to ensure privacy and prevent fraud in any of a variety of ways that are well known in the art.

Those of ordinary skill in the art will understand that vending machines and/or computers in communication with each other need not be continually transmitting to each other. On the contrary, such vending machines and/or computers need only transmit to each other as necessary, and may actually refrain from exchanging data most of the time. For example, a vending machine in communication with another machine via the Internet may not transmit data to the other machine for weeks at a time.

In an embodiment, a server computer may not be necessary and/or may not be preferred. For example, the present invention may, in one or more embodiments, be practiced on a stand-alone vending machine and/or a vending machine in communication only with one or more other vending machines. In such an embodiment, any functions described as performed by the computer or data described as stored on the computer may instead be performed by or stored on one or more vending machines.

In other embodiments, a vending machine may be in communication with a remote computer, such as a server, that provides the vending machine with and/or receives from the vending machine various data, such as all or some portion of the data described herein. Thus, in certain embodiments, the server may comprise certain elements or portions of certain elements such as a data storage device/memory.

In such an embodiment, the remote computer could be accessible, directly or indirectly, via a second computer (communicating over the Internet or other network) by a customer or another operator. Accordingly, a customer or other operator of the second computer (e.g., an owner of the vending machine) could communicate with the remote computer via a Web browser. The second computer could, e.g., receive from the remote computer messages described herein as being output by the vending machine, and/or transmit to the remote computer input described herein as being provided to the vending machine. Similarly, various data described herein as received through an input device of a vending machine may be received through a Web browser communicating with a remote server, which in turn communicates with the vending machine. Thus, an owner/operator of the vending machine may have remote polling and reporting capabilities, may be able to transmit new business rules to the vending machine, and the like.

Process Steps

Several process steps may be performed (e.g., by a vending machine control system or processor) in accordance with various embodiments of the present invention. In general, a vending machine (or control system thereof) of the present invention may be configured to (i) output a gift voucher comprising an inactive voucher identifier, (ii) activate the voucher identifier, (iii) receive the voucher identifier, and (iv) provide the gift.

Gift Certificate Activation Process

FIG. 3 illustrates a process for activating a gift certificate according to an embodiment of the invention.

Step 100. Dispensing a Vending Machine Product

It is well known in the art that various types of vending machines dispense products in various manners and in response to various inputs. For example, a vending machine may dispense a product upon receiving sufficient payment (e.g., a customer deposits $0.75) and upon receiving an indication of a desired product (e.g., a customer enters the row position identifier “A-1” using a keypad, and that row position designates a product having a price of $0.75). Such an indication may, for example, cause a vending machine control system to actuate one or more appropriate dispensing mechanisms (e.g., a motor rotates the dual spiral of row A-1 for one revolution) such that the desired product is pushed off of a shelf, falling under the influence of gravity into a delivery bin which is accessible by the customer, and is thereby dispensed. Various other methods of dispensing vending machine products are well known to those of ordinary skill in the art.

Step 200. Outputting a Gift Voucher Comprising an Inactive Voucher Identifier

As described in detail herein, a gift voucher may be output at various times and upon the occurrence of various events. For example, according to various embodiments, a gift voucher is output upon determining that a “triggering event” has occurred. As described in one or more embodiments, triggering events include but are not limited to (a) the dispensing of a product, (b) the sale of a product, and (c) the detection of the physical presence of a customer (e.g. via motion detector).

In an embodiment, a voucher identifier and its corresponding gift voucher are inactive when first output from a vending machine. Accordingly, such a voucher may not be redeemed unless and until the voucher is activated. In other embodiments, a voucher identifier and its corresponding gift voucher are active when first output from a vending machine. Accordingly, such vouchers would not need to be activated.

A voucher (and its corresponding voucher identifier) may be considered active if a gift giver has completed an activation process (e.g., has paid for the voucher). A voucher identifier may be considered valid if it (i) is active, (ii) has not yet expired, and (iii) has not yet been used to redeem a corresponding gift. Other restrictions may be imposed on the validity of a voucher identifier beyond those described immediately above. Only recipients who redeem valid voucher identifiers may be provided with corresponding gifts.

Generally, since the sale of gift vouchers can increase the profits generated by a vending machine, it can be desirable to output inactive gift vouchers frequently. One reason for frequently outputting inactive gift vouchers is that if many customers are presented with inactive vouchers, some portion of those customers may activate them (e.g., pay for them) and thereby increase revenues for operators.

Accordingly, in one embodiment, an inactive gift voucher may be automatically dispensed upon the completion of each vending machine transaction in which a product is dispensed (e.g., pursuant to a purchase of the product). Thus, in such an embodiment the step of dispensing a vending machine product represents a first “triggering event” (and dispensing a product may thereby satisfy a triggering rule that defines such a triggering event).

For example, a vending machine control system may actuate both a product dispensing mechanism (e.g., a helix used to dispense a unit of a Snickers® candy bar) and gift voucher printer substantially simultaneously (e.g., the printing and/or outputting of the gift voucher and the dispensing of a purchased product are initiated within about twenty seconds of each other). Various other “triggering events” may prompt the outputting of an inactive voucher (e.g., the output of coins from a change dispenser).

Other triggering events include (i) detecting the removal of a previously output inactive voucher (as described herein), (ii) detecting the presence of a prospective vending machine customer (e.g., via a motion sensor disposed to sense motion proximate to the front of the vending machine), (iii) the request of a customer (e.g., a customer actuates a “Print Gift Certificate” button), (iv) the dispensing of change by the vending machine, (v) any data related to a previous transaction (e.g., a “triggering rule” may indicate to output an inactive voucher if a previous transaction amount is equal to or greater than a threshold number), (vi) the purchase of a predetermined number of products (e.g., after a customer has purchased five products, after a customer has purchased five Coca-Cola® sodas), (vii) depositing coins or bills into the vending machine, (viii) rendering payment of any sort to a vending machine, and (ix) any data related to a previously dispensed product (e.g., a “triggering rule” may indicate to output an inactive voucher if a previously dispensed product's margin is equal to or greater than a threshold number).

Various types of triggering events described immediately above involve detecting and marketing to prospective vending machine customers. Various methods of detecting and marketing to prospective vending machine customers are described in Applicant's U.S. Pat. No. 6,324,520, entitled METHOD AND APPARATUS FOR COLLECTING AND APPLYING VENDING MACHINE DEMAND INFORMATION, issued Oct. 1, 1998, the entirety of which is incorporated by reference herein.

In an embodiment, the outputting of an inactive voucher may be performed at random times. For example, a vending machine may periodically generate a random number within a specified range. If the random number falls within a predetermined subrange of that specified range, an inactive voucher is output (e.g., a voucher bearing the text “Special Offer! Buy this $1.00 gift for $0.75!”).

An inactive voucher may be output in a variety of manners. Generally, in various embodiments, upon the occurrence of, e.g., a triggering event, a vending machine processor instructs an output device to output an inactive gift voucher.

In one embodiment, an output device comprises a “ticket” dispenser and an inactive gift voucher comprises a preprinted ticket (e.g., a paper or card substrate upon which indicia have been printed, embossed or otherwise registered) which is dispensed by the vending machine. Such substrate material may be loaded (e.g., by an operator) into a substrate feeder or other mechanism for dispensing or ejecting the substrate selectively (e.g., one at a time as commanded by the vending machine processor). Thus, upon receiving an instruction from a vending machine processor to output a gift voucher, a feeder may eject the preprinted voucher such that the voucher may be accessed externally by a vending machine customer (e.g., the preprinted voucher is ejected via a slot in the front of the vending machine).

Such preprinted vouchers may bear voucher identifiers (e.g., a ten digit number, a series of sixteen alphanumeric characters). Where voucher identifiers comprise characters or alphanumeric characters, the voucher identifiers can comprise a series of any number of characters. According to certain embodiments, voucher identifiers consist of a series of from seven to sixteen characters. Where the voucher identifiers are capable of being ordered, a set of preprinted vouchers may bear sequential voucher identifiers (e.g., each of one hundred preprinted vouchers bears a ten digit number, and the set of one hundred ten digit numbers are consecutive). A set of preprinted vouchers may bear non-sequential voucher identifiers, even if the voucher identifiers are capable of being ordered.

In one embodiment, for a set of preprinted vouchers there is a summary of the corresponding voucher identifiers of the set. For example, a set of one thousand preprinted vouchers may include a printed slip of paper and/or a stored computer file which identifies the one thousand corresponding voucher identifiers (e.g., a file stores the first voucher identifier and the last voucher identifier of the set of one thousand sequential voucher identifiers, a file stores each of the one thousand voucher identifiers). Accordingly, in one embodiment, the generation of a set of preprinted vouchers is accompanied by the generation of a summary of the corresponding voucher identifiers of the set. For example, a process may include the steps of (1) generating a set of (sequential or non-sequential) voucher identifiers, (2) storing the set of voucher identifiers (e.g., by storing a copy of each voucher identifier, by storing a beginning and end of a range of consecutive voucher identifiers, by storing a representation of an algorithm which may be used to generate or otherwise determine the set of voucher identifiers), and (3) printing each voucher identifier of the set onto a respective voucher, or onto a substrate (e.g., a label) which is to be affixed to or otherwise associated with a respective voucher.

In another embodiment, an output device comprises a printer and an inactive gift voucher comprises a small (e.g., the size of a credit card) piece of paper or card which the vending machine has marked. In one such embodiment, a blank piece of paper may be loaded by an operator into a vending machine printer or into a substrate feeder that supplies the paper to the printer, in a manner such that upon receiving an instruction from a vending machine processor to print a gift voucher, a printer may both (i) mark the voucher with various text, images or other symbols (e.g., while the voucher is still “inside” the machine), and (ii) output the marked voucher such that it may be accessed externally by a vending machine customer (e.g., the marked voucher is ejected via a slot).

For example, the selection of a bag of Doritos® chips can prompt a vending machine processor to actuate a printer, which prints an inactive gift voucher that bears the message “Pick any snack—$0.75 or less!”

Both printed and preprinted vouchers may be dispensed such that the voucher “dangles” from the vending machine but is not completely detached (e.g., from other paper that the voucher remains partially connected to). A customer can “tear off” the voucher, or can leave the voucher for the next customer.

In an embodiment, a voucher need not be requested from, paid for via, or dispensed by a vending machine. For example, a voucher may be purchased, e.g., via a web site. Further, in an embodiment where a voucher is requested from, paid for via, or dispensed by a web site, that voucher might be redeemed at a plurality of vending machines, e.g., all vending machines of an operator. In fact, regardless of whether a voucher is requested from, paid for via, or dispensed by a web site or a vending machine, that voucher might be redeemed at a plurality of vending machines, e.g., all vending machines of an operator (e.g., an operator of the vending machine).

A gift voucher may take various other forms. Examples of such forms include a plastic card bearing a magnetic stripe, a sticker or label that may be placed on a conventional greeting card, cardboard, card, paper or other substrate. Any physical form of gift voucher is contemplated as being within the scope of the present invention.

In addition, various non-physical forms of gift vouchers are contemplated, including vouchers embodied in email messages or in web pages. For example, a vending machine LCD screen may display the text: “Give a Gift of Five Cans of Soda—Only $3!” A gift giver may then purchase a corresponding voucher (e.g., by inserting $3 and pressing a “Buy A Gift Certificate” button) and indicating an e-mail address of a recipient. A voucher identifier (i.e., previously inactive, but activated at the time the voucher was purchased) is then sent via e-mail to the recipient. The recipient may then use the voucher identifier to redeem the gift(s).

Similarly, a vending machine operator can send a registered customer (or other party) an electronic message (e.g., an e-mail message) that includes a voucher identifier of an inactive voucher (e.g., the recipient receives a “gift code”).

In some embodiments, inactive gift certificates may be sent (e.g., by an operator) to customers through a traditional mail carrier (e.g., the United States Postal Service), rather than the vending machine outputting them to a customer. An inactive voucher may comprise various markings, such as one or more of text (e.g., activation instructions, etc.), numerals or alphanumeric characters (e.g., an activation code), symbols (e.g., a barcode that encodes a voucher identifier), icons, images, graphics and the like. As described, such markings may be printed or otherwise registered upon a substrate (e.g., paper substrate, card substrate, film substrate, plastic substrate) before they are loaded into a vending machine output device (e.g., a route driver fills a ticket dispenser with preprinted vouchers when restocking a vending machine) and/or may be printed upon substrate by a vending machine printer (e.g., after a transaction at a vending machine).

In one embodiment, corresponding gifts indicated by gift vouchers may be predetermined, such that the particular corresponding gift of a particular voucher is known (e.g., before being dispensed, before the transaction in which the voucher may be dispensed). In such an embodiment where the corresponding gift of particular voucher is predetermined, it can be advantageous to employ vouchers which are completely or partially preprinted, though preprinted vouchers are not required. For example, a central facility (e.g., maintained by an operator of the vending machine, maintained by an entity that supplies the operator) may print several stacks of gift vouchers that each bear the message “Pick any snack—up to $1”. Preprinted vouchers may then be distributed to route drivers, who are instructed to load the preprinted vouchers into vending machine dispensing units for use during an upcoming fill period. Nevertheless, although a voucher may be preprinted (e.g., in order to bear indicia which convey to a reader the corresponding gift of the voucher), additional indicia may be printed onto the voucher (e.g., immediately before dispensing the voucher) in various manners, for various reasons and to satisfy various goals as described herein.

Accordingly, in some embodiments in which a vending machine prints or otherwise registers indicia on a voucher, a vending machine of the present invention may comprise a printer that is operable to print various markings onto a substrate (which may be completely blank or which may be preprinted with various markings). Thus, various gift vouchers may be marked with different indicia (e.g., text or symbols) by the vending machine at various times (e.g., marked immediately before being output, marked upon the initiation of the vending machine transaction, marked during the vending machine transaction). Such embodiments are advantageous in permitting the issuance of gift vouchers which have a corresponding gift or other terms which are determined, e.g., after the substrate are loaded into the vending machine, immediately before being output. For example, in an embodiment where corresponding gifts are determined based on, e.g., frequently changing data such as vending machine sales and inventory data (as described herein), it can be advantageous to print, onto a substrate, indicia representing the corresponding gift at a time well after the substrate is loaded into the vending machine (e.g., upon the initiation of the vending machine transaction in which the voucher is output).

As stated, in some embodiments, an inactive gift voucher may comprise a voucher identifier. According to various embodiments, a voucher identifier may comprise one or more of the following: (i) a series of alphanumeric or numeric characters (an example of which is depicted on the voucher of FIG. 5), (ii) a barcode (an example of which is depicted in FIG. 6), (iii) a magnetic stripe which encodes data such as data representing encrypted numbers, and/or (iv) any marking that is readable by a human or by a machine, and that distinguishes different gift vouchers from each other.

In some embodiments, a gift voucher comprises an activation code. A gift giver may input an activation code (e.g., during an activation process) in order to activate a corresponding gift voucher. (However, as described herein, in some embodiments an inactive gift voucher may be activated without requiring the inputting of an activation code.) According to various embodiments, an activation code may comprise one or more of the following: (i) a series of alphanumeric or numeric characters (an example of which is depicted in FIG. 5), (ii) a barcode (an example of which is depicted in FIG. 6); (iii) any marking that is readable by a human or by a machine, and that can be interpreted as either corresponding or not to a voucher; and/or (iv) a magnetic stripe which encodes data such as data representing encrypted numbers. In one embodiment, an activation code comprises a voucher identifier (e.g., an activation code includes a series of characters which are a voucher identifier, a function may be applied to an activation code to derive a voucher identifier).

An inactive gift voucher may also comprise instructions for activating the voucher. For example, the voucher may bear instructional text that reads: “To activate this gift certificate, please deposit $0.75 and enter code 9-9287293.” In some embodiments, the gift voucher includes two or more portions. Further, the voucher may be structured or altered such that portions may be readily detached from each other (e.g., the voucher is perforated or creased along a boundary between the portions).

An ‘instructional portion’ of a gift voucher may be removed from a ‘recipient portion’ (an example of which is depicted in the voucher of FIG. 5). According to an embodiment, the instructional portion of the gift voucher may include markings that are appropriate for the gift giver (e.g., marking indicating the activation code, the price paid to activate the voucher). According to an embodiment, the recipient portion may include only markings that are appropriate for the gift recipient (e.g., markings indicating the gift product, but not indicating the activation code or price paid to activate the voucher). For example, in one embodiment, an instructional portion of a voucher is attached to a recipient portion of the voucher via a portion of the substrate which is perforated. In this manner, a gift giver may easily activate the voucher and provide only the recipient portion of the voucher to a recipient. Notwithstanding the example embodiments described herein, the instructional portion of a gift voucher may (but need not) include any information which is included on the corresponding recipient portion of that voucher, and vice versa.

In some embodiments, an inactive gift voucher may comprise ‘marketing text’ or other indicia which serve marketing or promotional goals. For example, in one embodiment, an inactive gift voucher comprises text that prompts customers to purchase a gift voucher (e.g., text that reads: “Buy someone a gift certificate today! It's a fun, easy way to say thanks or congratulations!”). In one embodiment, an inactive gift voucher may comprise a “To” section and/or a “From” section, such that a gift giver and gift recipient may later be indicated (e.g., the gift giver uses a pen to complete the sections with appropriate the information).

An inactive gift voucher may also comprise a description or indication of a corresponding gift (e.g., text which reads “One free Sprite® soda!”). As described herein, in some embodiments a corresponding gift of a voucher is predetermined (e.g., determined before a transaction in which the voucher is output). In one example consistent with such an embodiment, pre-printed inactive vouchers may be output, where each such voucher comprises an indication of a predetermined corresponding gift. In another example, a printer is instructed to mark each voucher in the same manner, such that each voucher offers the same predetermined corresponding gift.

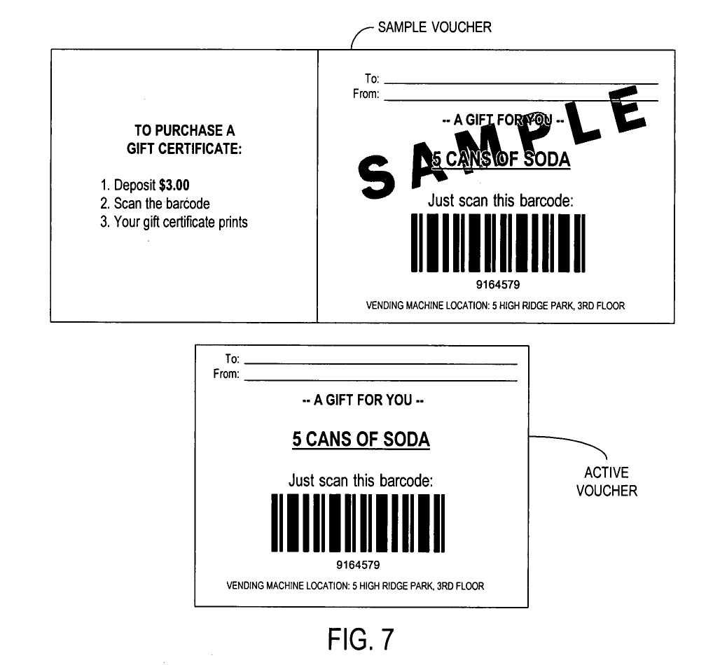

In an embodiment, a vending machine can output an inactive sample voucher (an example of which is depicted in FIG. 7). Such an embodiment can advantageously allow customers to more readily understand what a voucher is and what a voucher looks like, ameliorating concerns that the customer may have about purchasing a voucher.

For example, a vending machine may first output a sample voucher comprising, e.g., activation instructions, a voucher identifier and text indicating the voucher is only a sample. Upon activation, a vending machine may then output an active voucher, which in an embodiment is designed to look substantially similar to the inactive sample voucher. In this manner, a customer may (i) view a sample voucher comprising a voucher identifier, (ii) purchase (activate) the voucher, and (iii) receive an active voucher that bears the same voucher identifier as the inactive sample voucher. In one such embodiment, upon or before activating the voucher, a gift giver may have an opportunity to input or select text, graphics and the like to be printed on the active voucher. For example, the gift giver may specify information to be used in completing a “to/from” section of the voucher.

Further, in some embodiments, the voucher identifier on the sample voucher and the voucher identifier that is ultimately issued on an activated voucher may be different (e.g. for security reasons). In such an embodiment, the two different voucher identifiers may be related to each other, or one of the voucher identifiers can indicate or represent the other voucher identifier. For example, a database may store a record which allows one of the voucher identifiers to be indicated from the other voucher identifier (e.g., a record stores both voucher identifier). The database record may be indexed by one (or both) of the fields that store voucher identifiers, thereby generally permitting efficient searching of the database for the data in the indexed field(s).

Determining the Corresponding Gift

The product selected to be such a predetermined corresponding gift may be selected based on, e.g., the profitability (according to various measures) of selling such a product. For example, if Diet Coke® soda is the product in a vending machine with the highest sales margin (i.e., gross sales revenue per unit sold less direct costs attributable to the unit sold), an operator may program the machine to output only vouchers which may be redeemed for Diet Coke® soda. Thus, these vouchers, when activated and redeemed, would result in the highest sales margin per unit redeemed.

However, in other embodiments, a corresponding gift may be determined in other manners. Thus, in some embodiments the step of outputting an inactive gift voucher may comprise determining a corresponding gift of that voucher. As described herein, the voucher can (but need not) comprise an indication of the corresponding gift (e.g., text or other indicia that describe the corresponding gift). In an embodiment, an instructional portion of a gift voucher may indicate the corresponding gift of the voucher (e.g., $5 credit applicable to any products), and thus may serve as a receipt. The corresponding recipient portion of that voucher may indicate a corresponding gift with less precision than is provided by the indication on the instructional portion. Thus, corresponding recipient portion of that voucher need not disclose the exact value of the voucher, but may instead disclose, e.g., information that describes what products may be received upon redemption. For example, the corresponding recipient portion of a voucher may read “Pick any 5 items from the green inventory group!”. In such an embodiment, a gift giver may provide a voucher to a recipient without the recipient ascertaining precisely how much the gift giver paid for the voucher.

Several methods may be used to determine a corresponding gift. In one or more embodiments, a corresponding gift may be determined based on stored rules that are based, wholly or partially, on (i) the time of day and /or the date, (ii) a previously-dispensed product, (iii) current, historic or projected inventory data, (iv) current, historic or projected sales data, (v) the time elapsed since an event, and/or (vi) the time until an event is determined to occur or is predicted/estimated to occur. In some embodiments, rules for determining corresponding gifts may be constructed or selected in a manner that increases, or is intended to increase, vending machine profit, sales revenue or other criteria. In one example, an operator may program rules such that they are stored in a vending machine database.

Generally, a corresponding gift of a voucher can be determined based on one or more rules, in which each rule defines a corresponding gift for a particular value(s) of one or more inputs. In such an embodiment, the rule which matches the particular values of the measured inputs defines the corresponding gift(s) for the voucher. For example, in some embodiments, a corresponding gift of a voucher is determined based on one or more rules which consider the time of day and/or the day of the week. In one such embodiment, a vending machine control system can (i) access an internal or external clock to determine the current time of day and day of the week, and (ii) access a set of rules (e.g., which are stored in a “Business Rules Database”) to determine a corresponding gift based on the current time of day and day of the week. A Business Rules Database may, for example, comprise the following illustrative fields and data which define rules:

BUSINESS RULES DATABASE

| IF CURRENT TIME OF DAY AND | THEN CORRESPONDING |
|---|---|
| DAY OF WEEK IS: | GIFT IS: |
| Monday through Friday, from 9 a.m. to | “Pick any snack - up to $0.75” |
| 5 p.m. | |
| Monday through Friday, from 5 p.m. to | “Pick any snack - up to $1” |
| 9 a.m. | |
| Saturday through Sunday | “Pick any two bags of chips - up |
| | to $1 each” |

In the illustrative business rules database immediately above, each record of the database defines an offer for a corresponding gift for various current times of day and days of the week. The rules for those times/days which are expected to experience relatively lower sales can specify corresponding gifts which are relatively more desirable (e.g., redeemable for products of relatively greater value). In this manner, sales may be increased since the offering of relatively valuable gift vouchers for sale may attract consumers to vending machines during “off-peak” hours.

In other embodiments, a corresponding gift may be determined based on a previously dispensed product. Generally, it can be advantageous to output a voucher for a product already purchased by a customer. For example, if a Twix® bar was selected by a customer and dispensed, a rule may indicate to output an inactive gift voucher having a corresponding gift of “One free Twix® bar” (i.e. one unit of the product that had been purchased by the customer). In this manner, corresponding gifts may be marketed to vending machine customers based on individual tastes, thus increasing the customer's affinity toward inactive gift vouchers and potentially increasing sales of gift vouchers.

In an embodiment, a corresponding gift may be determined based on whether a previously dispensed product (e.g., a product purchased by a customer) has a sales margin equal to or greater than a threshold amount (e.g., sales margin of $0.30 or greater). In still another embodiment, a corresponding gift may be determined based on whether a previous amount the customer paid for a vending machine transaction was equal to or greater than a threshold amount (e.g., the customer spent at least $1.00).

In further embodiments, a corresponding gift may be determined based on inventory data, such as the absolute or relative amounts of various products which are available for sale by the vending machine. For example, a rule may specify that the corresponding gift is the product with the most units of inventory currently in stock. The product with the most units of inventory currently in stock may, very generally, be considered the product most likely to have the lowest ‘sales velocity’ (i.e., units sold per time, such as per day). Therefore, providing a gift voucher redeemable for such a product can increase sales of that product and reduce the number of unsold units of that product. In this manner, profit may be increased as items that may not sell during conventional vending machine transactions are marketed and sold to customers via gift vouchers. Such rules may be stored in a Business Rules Database.

In still further embodiments, a corresponding gift may be determined based on sales data. For example, a rule may specify that a corresponding gift is the product that is selling at the lowest actual ‘sales velocity’. In this manner, profit may be increased as items that are selling relatively poorly during conventional vending machine transactions are marketed to customers via gift vouchers. Such rules may be stored in a Business Rules Database.

In embodiments where a stored rule specifies a corresponding gift based on sales or inventory data, such data may be stored in and accessible via a (local or remote) “Sales and Inventory Database.” As is known, such a database is typically “updated” as products are sold, dispensed, restocked, etc. to reflect changed sales and inventory data. For example, the purchase of one unit of a Snickers® bar would result in the reduction of an inventory count of that product by one unit, and increases an actual sales rate of that product accordingly. In one embodiment, a Sales and Inventory Database may, for example, comprise the following illustrative fields and data:

SALES AND INVENTORY DATABASE

| | | | | | Actual | Days |
|---|---|---|---|---|---|---|
| | Unit | Retail | | Units in | Sales | until |
| Product | Cost | Price | Margin | Inventory | Velocity | Restock |
| Snickers ® | $0.55 | $0.75 | $0.20 | 7 | 1.15/day | 10 |
| bar | | | | | | |
| Milky Way ® | $0.50 | $0.65 | $0.15 | 15 | .75/day | 10 |
| bar | | | | | | |
| Twix ® bar | $0.60 | $0.65 | $0.05 | 21 | .45/day | 10 |
| Dentyne ® | $0.10 | $0.35 | $0.25 | 24 | .30/day | 10 |
| gum | | | | | | |
| Cheetos ® | $0.30 | $0.60 | $0.30 | 18 | .60/day | 10 |
| snack | | | | | | |
| Doritos ® | $0.35 | $0.60 | $0.25 | 4 | 1.30/day | 10 |
| chips | | | | | | |

Such a database, or another database, may include data regarding particular sales or other transactions (e.g., transactions which involve products being sold or dispensed). In one embodiment, a Transaction Database may, for example, comprise the following illustrative fields and data:

Transaction Database

| Trans- | | | | | Product(s)/ |
|---|---|---|---|---|---|
| action | Transaction | | | Revenue | other Item |
| ID | Description | Date | Time | Received | Dispensed |
| 11000 | SALE | Jan. | 11:02 AM | $0.75 | Snickers ® |
| | | 1, 2007 | | | bar |
| 11001 | SALE | Jan. | 11:19 AM | $0.60 | Cheetos ® |
| | | 1, 2007 | | | snack |
| 11002 | VOUCHER | Jan. | 11:20 AM | $0.70 | Voucher ID |
| | ACTIVATED: | 1, 2007 | | | 9-12345678 |
| | Voucher ID 9- | | | | |
| | 12345678 | | | | |
| 11003 | VOUCHER | Jan. | 12:42 PM | $0.00 | Snickers ® |
| | REDEEMED: | 1, 2007 | | | bar |
| | Voucher ID 9- | | | | |
| | 12345678 | | | | |

It will be readily apparent to one of ordinary skill in the art that certain data included in the Transaction Database may be used to compute data included in the Sales and Inventory Database. For example, the ‘actual sales velocity’ included in the Sales and Inventory Database can be computed by determining the average number of units sold per day, and that average may be determined from the Transaction Database. Specifically, the illustrative Transaction Database above provides information regarding which products were sold, and when those products were sold.

Various other business rules and techniques for determining vending machine promotions (e.g., a corresponding gift of a gift voucher) based on sales and inventory data are described in Applicant's co-pending U.S. patent application Ser. No. 10/855,247, filed May 27, 2004, and all applications cited therein, each of which is incorporated by reference herein.

In an embodiment, there may be a plurality of rules (e.g., stored by a Business Rules Database) for determining corresponding gifts, but rules may be either ‘active’ or ‘inactive’, such that a rule which is ‘inactive’ does not determine a corresponding gift, even if that rule is satisfied. Such an embodiment can be advantageous, e.g., where it is desirable to modify which rules are in effect and which are not, without deleting or adding rules. In particular, the selective inactivation of one or more rules can be advantageous, e.g., where an operator wishes to firmly control the determination of corresponding gifts according to various criteria. For example, an operator may chose to enable (activate) only one particular rule at a time (e.g., a memory is encoded with a program to execute only one predetermined rule when determining a corresponding gift).

A subset of rules may be made active and the remaining rules made inactive by a human or automatically by a device. For example, an operator may indicate, via an appropriate interface such as a graphical user interface to a database, which rules are to be made active and which are to be made inactive (e.g., by checking or unchecking boxes that correspond to the rules). A device, e.g., a computer operating under the control of an appropriate program, may automatically activate and/or deactivate certain rules (e.g., at predetermined times and/or under predetermined conditions).

Further, rules may include a relative precedence, such that if more than one rule is satisfied, the relative precedence determines which of the rules is employed to determine the corresponding gift. For example, a ‘standing rule’ may be assigned the lowest precedence, such that the standing rule is ‘replaced’ by another rule (e.g., the other rule, not the standing rule, determines the corresponding gift) if certain conditions of the other rule are satisfied. For example, a standing rule may specify as a corresponding gift the vending machine product with the highest sales margin (e.g., Cheetos® snack product). An operator may then indicate to ‘replace’ the standing rule only when certain other rules are satisfied. For example, a second rule may indicate that if a product has an actual sales velocity of less than 0.25 units per day, then that product should be selected as a corresponding gift (instead of Cheetos® snack product specified by the standing rule).

It is possible that a single rule (or even a plurality of rules) is satisfied by more than one product. The corresponding gift may be selected from this plurality of product (e.g., randomly). A “tie breaking” rule may also be used to select among a plurality of products which satisfy a rule, and therefore select a corresponding gift from the plurality of products. For example, a tie breaking rule may specify that if two products satisfy a rule because both products have the same (greatest) sales margin, then select the product that has the greatest sales margin and the lowest actual sales velocity as the corresponding gift.

In an embodiment, corresponding gifts may be determined randomly. For example, a corresponding gift may be randomly selected from the set of all products available for dispensing by a vending machine, or from a subset thereof (e.g., the subset which represents the four products with the lowest sales velocity).

In various embodiments, gift vouchers can enable recipients to redeem several different types of gifts, including but not limited to (i) vending machine credit (e.g., $1 redeemable toward any vending machine purchase), which is an increase in the amount of funds that are available to pay for a purchase of a product (though not necessarily available for refunding in the form of, e.g., currency); (ii) one or more products, such as a particular product (e.g., a Snickers(D bar); (iii) one or more products selected from a certain category or inventory group (e.g., any bag of chips, any product in the “green” group); and/or (iv) a discount applicable to any of the foregoing (e.g., get any $1 product for ten cents; get a Snickers® bar for half price, get any one bag of a chip product for twenty five cents). Methods of allocating vending machine products to inventory groups based on sales and inventory data (as well as based on other considerations) are discussed in detail in Applicant's co-pending U.S. patent application Ser. No. 10/902,347, filed Jul. 29, 2004, which is incorporated by reference herein.

In an embodiment, the corresponding gift is based, partially or completely, on the identity of the gift giver, where the vending machine identifies the gift giver. A vending machine may identify a customer in various ways. For example, a customer may have been assigned a customer identifier (e.g., a series of numeric or alphanumeric characters), and the customer identifier can be received by the vending machine (e.g., through an input device such as a keypad). Other types of customer identifiers include biometric data (e.g., the customer's fingerprint or iris print) which may be received by the vending machine through an appropriate biometric reader (e.g., a fingerprint scanner, an iris scanner). A customer identifier may also be encoded by an object carried by the customer, such as a plastic card with a magnetic strip, a paper card comprising a barcode, an RFID transmitter, keyfob or the like which transmits (actively or passively) an RF signal encoded with the customer identifier.

Once the customer has been identified, the purchase history of the customer may be determined (in an embodiment where the purchase history of customers is recorded, e.g., in a customer database). The corresponding gift of an inactive gift voucher may then be determined based on such purchase history. For example, a customer who frequently purchases one type of Frito-Lay® product (e.g., Cheetos® snack chips), may be presented with an inactive “Free bag of Fritos® chips” gift voucher (Fritos® chips being another Frito-Lay product).

In another embodiment, a customer may “register” with a vending machine (or, for example, with a network of multiple vending machines managed by the same operator) by providing various contact information (e.g., an e-mail address). Upon registering, a customer may, among other things, indicate various preferences. Such preferences may include a “wish list” of gift voucher offers the customer would like to be presented with once being the customer is identified by a vending machine.

Step 300. Receiving a Request to Activate the Voucher

Generally, in various embodiments, a vending machine processor receives a signal from a vending machine input device (e.g., a keypad, a touch screen, a bar code scanner), where that signal indicates a request to activate a voucher. In some embodiments, one or more databases are used to track whether a voucher is active (as well as, e.g., whether the voucher has been redeemed or has expired). Thus, the database may be consulted such that recipients presenting valid vouchers are provided with appropriate gifts, while recipients presenting inactive or otherwise invalid voucher identifiers are not.

A customer or gift giver may indicate a desire to activate a gift voucher in a variety of manners. For example, a customer may request to activate a voucher identifier by pressing a button. In one embodiment, a button comprises an appropriately labeled portion of a touch-screen LCD (e.g., a portion comprising the text: “Buy a Gift Certificate”). In another embodiment, a button is a mechanical or electromechanical device (e.g., an “Activate Certificate” button).

Thus, in various embodiments of the present invention, a customer may (i) first indicate their desire to purchase a gift voucher (e.g., by pressing a physical or graphical “Buy a Gift Certificate” button), and (ii) indicating the voucher to activate, typically by entering a particular voucher identifier. Specifically, after indicating their desire to purchase a gift voucher, the vending machine can (i) dispense an inactive gift voucher, (ii) dispense an active gift voucher, and/or (iii) activate an already-printed inactive voucher.

Conversely, in various embodiments of the present invention, a customer may (i) enter a particular voucher identifier, and then (ii) confirm their desire to activate the particular identifier. For example, after a customer has entered a voucher identifier using an external keypad (e.g., to enter the series of numeric characters: ‘9019920’), a vending machine output device (e.g., an LCD) may then display a message reading, “Would you like to activate this gift certificate redeemable for One Free Sprite® soda?” The customer may then confirm his intent to activate the voucher, for example, by pressing a “Yes” or “Enter” button of the keypad.

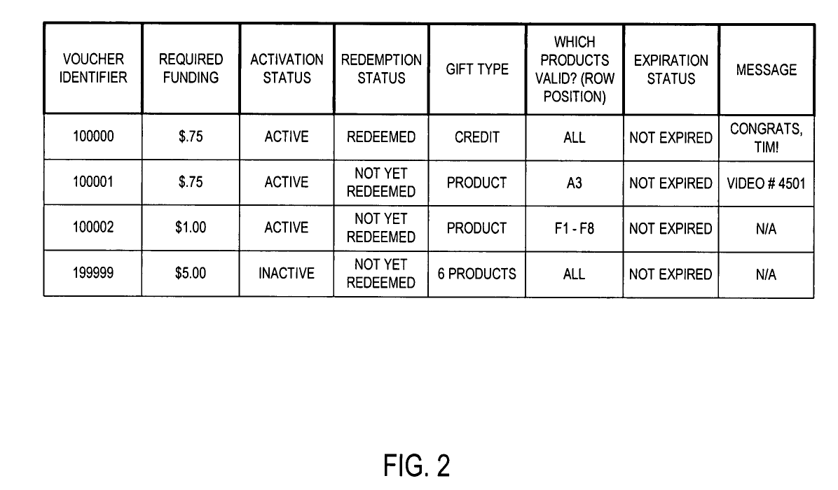

Further, a customer might enter a voucher identifier by inputting the inactive voucher itself. For example, a vending machine may comprise a means for determining the voucher identifier from the voucher (e.g., by reading the barcode on the inserted voucher to determine a voucher identifier). In this manner, a customer may approach a vending machine and insert an inactive voucher into a slot (e.g., marked with the text “Insert Voucher Here”). The vending machine control system can then command a reader (e.g., a bar code scanner) to determine the voucher identifier from the voucher, and then determine that the voucher identifier has not yet been activated (by accessing a “Voucher Database” such as the database depicted in FIG. 2). The vending machine could then output a confirmation message (e.g., “Would you like to activate this gift certificate for One Free Sprite®?”) to request that the customer verify that he desires the voucher to be activated. In an embodiment, an external reader (e.g., an infrared barcode scanner disposed to read bar codes that are located proximate and external to the vending machine) may be used to determine a voucher identifier.

In another embodiment, a customer may request that a voucher be activated by entering an activation code. For example, a customer may enter a numeric activation code (e.g., using a keypad). In one embodiment, a first character (or the first of a plurality of characters) of an activation code may be used to denote that an activation code (as opposed to, e.g., a selection of a product) is being received (e.g., any time a customer enters the number ‘9’ first, the customer is not selecting a product for a conventional vending machine transaction). In some embodiments, an activation code may comprise a voucher identifier (e.g., if an activation code is ‘9019289’, the voucher identifier is the sequence after the initial ‘9’, namely ‘019289’). Alternatively, activation codes need not adhere to any particular format (such as beginning with the same character or plurality of characters).

In another embodiment, a sensor may be used to detect the removal of a gift voucher. For example, an infrared sensor may be positioned to sense the presence or absence of a gift voucher which is output so that it is partially located external to the vending machine (e.g., dangling from the vending machine). If that gift voucher were then removed from the vending machine by the customer, the sensor would detect the absence of the voucher. Upon sensing the removal of the voucher, the vending machine could output a message via display device (e.g., “Would you like to purchase this gift certificate?”). The customer may then indicate a desire to purchase the gift voucher, for example, by pressing an enter button of keypad or a “yes” button of a touch-sensitive LCD.

A voucher may be activated remotely from a vending machine (e.g., by visiting a Web site, identifying the voucher, and providing a valid credit card account number to be charged the requisite amount. In an embodiment, the voucher may be identified by entering a voucher identifier (e.g., via an HTML form). Alternatively, the voucher may be identified by allowing the gift giver to select a particular gift from among a plurality of gifts, and an appropriate voucher would be generated and/or the voucher identifier output.

A voucher activated remotely may be printed (e.g., using a peripheral device of a personal computer) to allow the active voucher to be given to a recipient.

In an embodiment, if the vending machine detects that an inactive voucher has been removed from a vending machine, the vending machine outputs another inactive voucher. In an embodiment, if a sensor detects that an inactive voucher has not been removed, the voucher may be retracted (e.g., an inactive voucher “dangling” externally from a printer is pulled back inside the vending machine by a motorized feeder mechanism). Optionally, the voucher may only be retracted if one or more stored rules are met. For example, a stored rule may indicate to retract an inactive voucher if a specified amount of time has elapsed since the voucher was initially output (e.g., five minutes). Another rule may indicate to retract and inactive voucher if a motion sensor detects no potential customers in proximity to a vending machine. Methods of detecting prospective vending machine customers are discussed in Applicant's U.S. Pat. No. 6,324,520, entitled METHOD AND APPARATUS FOR COLLECTING AND APPLYING VENDING MACHINE DEMAND INFORMATION, issued Oct. 1, 1998, the entirety of which is incorporated by reference herein.

In some embodiments, receiving a request to activate a voucher can comprise receiving a message from a gift giver. Such a message may then be output to a recipient as described herein. For example, a customer may use a touch-screen input/output device to enter a text message such as “Happy Birthday Tony!”, or to select from among a plurality of predetermined messages. In other embodiments, a recording device (e.g., a microphone, an image capture device, a video camera) may be utilized such that a gift giver may record an audio, image, or audiovisual message for an interval of time (e.g., starting and stopping recording as specified by the gift giver in a known manner).

A message may be input by a gift giver via a Web site accessed by, e.g., a personal computer, rather than via an input device of a vending machine. In such an embodiment, the gift giver may specify (e.g., via an HTML form) the voucher identifier of the voucher, and the text, images, etc. to be included in the message. Various contact information pertaining to gift givers (e.g., the email addresses of recipients) may be captured during this process, such that a vending machine operator may gain an opportunity to market to customers (e.g., via electronic mail).

Message data may be associated with a voucher identifier and then stored in a Voucher Database or Message Database (which associates various message data with a voucher). In embodiments wherein message data requires substantial storage space (i.e. audio/video messages), the message data may be stored on a device remote from the vending machine, such as a server accessible to the vending machine via a network.

Step 400. Determining if the Request to Activate is Valid

In some embodiments, a request to activate a voucher identifier is valid if a gift giver has deposited appropriate payment. For example, in order to activate a “Pick any snack—up to $1.00” gift certificate, a gift giver must first render appropriate amount of payment (e.g., by inserting a dollar bill into a vending machine bill acceptor, by inserting $1.00 of coins into a change acceptor, by swiping a credit card through a credit card reader of the vending machine, by entering a code which indicates an account which may be used to render payment). If an amount of payment is required to activate a voucher, the amount may, but need not, be equal to the redemption value of the voucher. For example, if a voucher is redeemable for any snack up to $1.00, then the amount of payment required to activate the voucher may be, but need not be, $ 1.00.

In an embodiment where the amount of payment required to activate a voucher is less than the redemption value of the voucher (e.g., Twizzlers® snacks retail price is $0.75, and a voucher for Twizzlers® snacks costs $0.65), it can be advantageous to impose redemption restrictions on such a voucher. For example, a time-based restriction (e.g., allowing redemption only after twenty-four hours after the voucher is activated) will tend to discourage gift givers from buying vouchers for themselves simply to acquire the ‘discount’ on a product.

In an embodiment, the gift giver may be provided with an incentive to activate a voucher. For example, the gift giver may be provided with his own voucher (e.g., of equal value to the voucher he has activated) for free upon activation of the first voucher.

In an embodiment, the amount of payment required to activate the voucher is an amount of change due to the customer as the result of the customer's vending machine transaction. For example, a customer may approach a vending machine, insert $1.00, and purchase a bag of Cheetos® snack for $0.60. A vending machine output device (e.g., printer) may then present a “dynamically priced upsell offer” to the customer (e.g., an inactive voucher comprising the text “Get this Snickers® gift certificate instead of your change!”). The customer could purchase the gift certificate, e.g., by following an activation process as described herein. Dynamically priced upsell offers are discussed at length in Applicant's U.S. Pat. No. 6,397,193, entitled METHOD AND APPARATUS FOR AUTOMATICALLY VENDING A COMBINATION OF PRODUCTS, issued May 28, 2002, the entirety of which is incorporated by reference herein.

Thus, in some embodiments, determining if a request to activate a voucher identifier is valid comprises the steps of (i) determining a voucher identifier (in some embodiments, this may have been received as described above with respect to Step 300), (ii) determining an amount of payment required (if any), and (iii) determining if the customer has met the amount of payment required by rendering sufficient payment.

For example, if a customer enters a voucher identifier of ‘100002’, a vending machine processor may access a Voucher Database, determine the corresponding amount of payment required (e.g., $1.00), and determine whether the customer has input sufficient payment (e.g., via a bill acceptor, a coin acceptor or a credit card reader). If the customer has rendered sufficient payment, the activation request would be considered valid.

In an embodiment, a voucher may be activated even without a gift giver having rendered appropriate payment, provided the gift giver has provided a means to collect payment. For example, the gift giver may provide a payment identifier, such as a credit card account number, a debit card account number, or the like. The payment identifier may be provided via an input device (e.g., a keypad) or (where the payment identifier was previously provided by the gift giver and stored) retrieved from a record of a customer database associated with the gift giver.

In an embodiment where the gift giver does not render payment upon activation of the voucher, the gift giver may be charged, e.g., upon the redemption of the gift certificate. For example, a first customer (a gift giver) may affirmatively request or be offered the opportunity to register a gift certificate with a credit card account, a stored value account, and/or a prepaid unit (“subscription”) account (as described in Applicant's U.S. Pat. Nos. 5,988,346; 6,085,888 and 6,298,972; and in Applicant's co-pending PCT Application No. 2004/041561, filed Dec. 9, 2004; the entirety of each of these patents and applications is incorporated by reference herein).

The vending machine or computer associated therewith honors the registration request by associating in a database a voucher identifier with the customers' account identifier. Then, the voucher corresponding to the voucher identifier may be given by the gift giver to a gift recipient, who may in turn present the voucher (and/or information thereon) to a vending machine during a redemption process. In one embodiment, a gift giver provides a physical voucher to a gift recipient. In another embodiment, a gift recipient causes a voucher and/or voucher identifier to be provided to a gift recipient through a communication network (e.g. via email, instant message). Thus, in one embodiment, pursuant to the registration process, a gift giver may enter the gift recipient's communication address (e.g. email address, phone number, etc.), so that the vending machine and/or computer associated therewith (e.g. a central server) may transmit the voucher and/or voucher identifier to the gift recipient through the communication network upon completion of the activation process.

Thereafter, pursuant to the redemption process, the vending machine (or a computer associated therewith) receives gift certificate information (e.g. read a bar code on the voucher), determines the associated (gift giver's) account based on the received gift certificate information, and charges the account for an amount (e.g. the face value of the gift certificate). Thus, in such an embodiment the gift giver would only pay for the gift when and if the gift giver redeems the voucher.

Step 500. Activating the Voucher

In some embodiments, if a request to activate a voucher is valid, the voucher is then activated and may thereafter be redeemed (e.g., by a recipient).

In one or more embodiments, a voucher is considered active once a vending machine processor “updates” a field (re-encodes RAM or other storage device where the appropriate data is stored) of a database associated with the voucher (e.g., identified by the corresponding voucher identifier). For example, with reference to FIG. 2, each voucher identifier may have a corresponding “activation status” of “active” or “inactive.”Thus, in some embodiments, the step of activating a voucher identifier comprises changing this activation status for the corresponding database record from inactive to active.

Gift Certificate Redemption Process

Step 100. Receiving a Voucher Identifier

A recipient wishing to redeem a voucher may do so by identifying the voucher (e.g., by providing a valid voucher identifier to the vending machine). In some embodiments, before inputting a voucher identifier, a recipient may first indicate an intent to redeem a gift certificate (e.g., a customer presses a “Get My Gift” button of a touch-sensitive LCD on the vending machine).

As described herein, a recipient may input a voucher identifier in a variety of manners, including but not limited to any method described herein for activation of a voucher. A voucher identifier input by a recipient may be considered “received” by a vending machine control system.

Step 200. Determining Whether the Voucher (Identifier) is Valid

In some embodiments, once a voucher identifier is received, a corresponding gift may not be provided unless the voucher identifier is valid. As described herein, according to an embodiment, a voucher identifier (and thus the voucher that it identifies) may be considered valid if the corresponding voucher (i) is active, (ii) has not yet expired, and (iii) has not yet been used by a recipient to redeem a gift.

Accordingly, in one or more embodiments, a vending machine processor may access one or more fields of a Voucher Database in order to determine an activation status, redemption status and/or expiration status (if there is an expiration period) for each received voucher identifier. In this manner, if a received voucher identifier is “active,” “not redeemed” and “not expired,” a corresponding gift may be provided (e.g., as depicted in the record for voucher identifier “100001” illustrated in FIG. 2).

Step 300. Providing a Corresponding Gift

In one or more embodiments, a valid voucher may entitle a recipient to a specific vending machine product (e.g., one Twix® bar). In one such embodiment, upon receiving a valid voucher identifier, a vending machine processor may actuate one or more dispensing mechanisms such that the product corresponding to the gift product is delivered to the recipient (e.g., a helix for a particular row position is rotated one revolution such that a Twix® bar is pushed off of a shelf, falling under the influence of gravity into a delivery bin which is accessible by the recipient). Various methods for dispensing products from a vending machine are well known.

In other embodiments, a valid voucher may entitle a recipient to select one or more products from one or more inventory groups. In an embodiment, an inventory group may comprise every product of a vending machine (e.g., a gift is “Pick any one item”). In other embodiments, an inventory group may comprise a category of products (e.g., a gift is “Pick any one bag of chips”). For example, with reference to FIG. 2, a gift recipient presenting the valid voucher identifier “100002” may be entitled to select any product in “Row F” of a vending machine. In further embodiments, an inventory group may be visually communicated to a recipient (e.g., if a gift is “Pick any green item,” a green LED adjacent to each product of the inventory group may be actuated). Inventory groups are described in Applicant's co-pending U.S. patent application Ser. No. 10/902,347, filed Jul. 29, 2004, which is incorporated by reference herein. In an embodiment, inventory group allocations based on current sales and inventory data made at the time of voucher redemption are employed, because they may be considered more optimal than those allocations made, e.g., at the time of voucher activation (i.e., allocations at redemption are consider more recent, “up-to-date” sales data).

Once presented with an inventory group, a recipient may select a particular product. A vending machine processor may access a Voucher Database to determine if a recipient has selected a valid product (i.e., a product that is included in the indicated inventory group). For example, with reference to FIG. 2, a recipient who presents voucher identifier “100002” and selects a product in row position B-2 would not be provided with the selected product (since only row positions F1 through F8 are valid). In one embodiment, an inventory group may be presented to a recipient as a menu of product options via touch-sensitive display screen. In this manner, a recipient may select a product by touching an icon (e.g., an image of a bag of Doritos®) or other indication that represents the product.

Further, in an embodiment wherein a gift comprises a vending machine credit (e.g., $0.75), a recipient may select any item with a retail price equal to or less than the credit amount. The recipient may alternatively tender additional payment, which is added to the vending machine credit and would permit the recipient to select any item with a retail price equal to or less than the (increased) credit amount.

In an embodiment, a voucher may entitle a recipient to receive more than one product (such as a vending machine subscription for “5 cans of any soda”). In one such embodiment, each time a recipient inputs a valid voucher identifier and redeems a unit of a product, a database record associated with the voucher is adjusted appropriately to reflect the redemption (e.g., the record stores the number of units remaining to be redeemed, and that number is decremented by one product unit).

Subscriptions and subscription offers are described in Applicant's U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; U.S. Pat. No. 5,988,346, entitled METHOD AND APPARATUS FOR ESTABLISHING AND MANAGING VENDING MACHINE SUBSCRIPTIONS, issued Nov. 23, 1999; and PCT Application No. 2004/041561, filed Dec. 9, 2004; the entirety of each of these patents and applications is incorporated by reference herein.

In an embodiment, a voucher may entitle a recipient to receive an item from a “satellite device” that is in communication with the vending machine. Such a satellite device is typically, but need not be, proximate to the vending machine. The vending machine may control the satellite device, such as by commanding the satellite device to dispense an item, allow an item to be withdrawn from the satellite device, and the like. The vending machine may additionally or alternatively exchange various status information with the satellite device, such as data indicating products available, their prices, and the like.

The item received from a satellite device may be in addition to or instead of items dispensed directly by the vending machine. For example, a satellite device may comprise a newspaper dispenser, which the vending machine controls to selectively allow a newspaper to be removed. A customer redeeming a voucher may be entitled to a free newspaper in addition to the gift product he receives from the vending machine.

Further, it can be advantageous to combine vouchers redeemable for a plurality of units with a satellite device which dispenses items typically consumed over time (such as consecutive editions of a newspaper or magazine). Such combining of vending machine and satellite device would tend to promote redemption of vending machine products at frequencies generally dictated by the consumption of the satellite device product. For example, consumers that received a free newspaper with each redemption of a “ten cans of soda” gift voucher would tend to redeem a soda from the vending machine every day (in order to receive their daily paper).

In an embodiment, upon providing a gift to a recipient, a vending machine outputs a message to a recipient. For example, a gift giver may have previously input a message (e.g., when activating the voucher as described above). In some embodiments, such a message comprises text, which is output to a recipient by means of any of a variety of output devices, including but not limited to printers, LED displays, LCD screens, text-to-speech synthesized audio and the like. In some embodiments, such a message comprises pre-recorded audio. Such audio may be output to a recipient via an audio module comprising audio speakers and appropriate audio device drivers. In some embodiments, such a message comprises pre-recorded video. Such video may be output via a display device (e.g., an LCD screen).

In an embodiment, the message may be output to a recipient via a Web site. For example, the recipient's voucher may bear a URL (e.g., the text: “A Gift for You—One Free Diet Coke® —To find out more, log on to www.nextvend.com/gifts and enter code “1003457.”) The recipient may access the Web site specified by the URL and view the message (e.g., an electronic greeting card) that was input by the gift giver. Various contact information pertaining to recipients (e.g., the email addresses of recipients) may be captured and stored during this process, such that a vending machine operator may gain an opportunity to market to customers (e.g., via electronic mail).

In some embodiments, message data may be stored in and/or accessed from a remote storage device (e.g., a vending machine processor retrieves message data from a remote server via a wireless network).

In an embodiment, the providing of the corresponding gift is accompanied by the dispensing of a “gift-wrap” item. Such items may be decorative in nature. Illustrative gift-wrap items include a bow, a folded cardboard gift box, a gift bag, an envelope, collapsible baskets, gift bags, cards (blank “Thank you” cards, blank “Thinking of you” cards, blank generic cards) and the like. In an embodiment, a gift giver may have indicated the names of the gift giver and the recipient (e.g., using a touch-sensitive LCD screen) before the gift-wrap item is dispensed, such that a printer may mark a “To/From” section of the gift-wrap item with the indicated names.

Additionally or alternatively, dispensing of a gift-wrap item may occur when an inactive gift voucher is output, when an inactive gift voucher is activated. It can be advantageous if gift-wrap items include a “To/From” section that a gift giver may fill in (e.g., using a writing instrument).

With the availability of such “gift-wrap” items as described above, it can also be advantageous to offer such “gift-wrap” items for sale.

In an embodiment, the providing of the corresponding gift is accompanied by the output of a music file. For example, a recipient may select a particular song to be downloaded to a portable music device (e.g., an Apple iPod® player) or other destination device. The vending machine retrieves a file of that song and copies it to the destination device. The outputting of a music file may be accompanied or preceded by a promotional message, such as “Get your snack, and a free song!”

In an embodiment, the receipt of the gift is conditioned upon the recipient entering a communication address (e.g., one or more of the recipient's email address, postal mailing address, and telephone number) and/or other recipient data (e.g., recipient name, survey data). For example, an output device of the vending machine may output a text message “Enter your email address to redeem your gift”. The recipient then may use a touch screen or keypad to enter his email address, and the gift is then dispensed. In an embodiment, the providing to the recipient of the voucher or voucher identifier would also communicate to the recipient that the receipt of the gift is conditioned upon the recipient entering certain data. For example, a paper voucher may include the message “Enter your email address and get a free snack”. In another example, an email including the voucher identifier (e.g., which was sent to the recipient) may also include text such as the message “Enter your email address and get a free snack”.

Such an embodiment can promote the collection (e.g., by the vending machine operator) of useful information. For example, the collection of communication addresses can facilitate various types of marketing and promotional initiatives.

In an embodiment, when the receipt of the gift is conditioned upon the recipient entering a communication address and/or other recipient data, the corresponding amount of payment required to activate the voucher can be substantially less than the redemption value of the voucher. For example, if a voucher is redeemable for any snack up to $1.00, then the amount of payment required to activate the voucher may be, e.g., $0.20. Accordingly, the gift giver (or other party paying the amount of payment required) would pay only 20% of the redemption value of the voucher.

In an embodiment, the receipt of the gift is conditioned upon the recipient providing payment. The recipient may be required to pay any price (although iun many circumstances the recipient would be required to pay less than the corresponding price of the gift). The payment which the recipient must pay to receive the gift may (but need not) be the difference between (i) the retail price of the gift (e.g., the retail price of the product for which the voucher is redeemable), and (ii) the amount of payment required to activate the voucher (e.g., paid by the giver). In other words, the retail price of the gift may be effectively divided between the recipient and the gift giver. For example, the amount of payment required to activate the voucher is $0.60, and the payment which the recipient must pay to receive the gift is $0.25, where the gift is a product with a retail price of $0.85.

In an embodiment, the payment which the recipient must pay to receive the gift is a denomination which is convenient to pay (e.g., multiples of a quarter, multiples of a dime, multiples of a nickel, whole dollar amounts).

In an embodiment, the retail price of the gift is effectively divided between the recipient and the gift giver, but the recipient pays significantly less than the gift giver pays.

In an embodiment, when the receipt of the gift is conditioned upon the recipient entering a communication address and/or other recipient data, the corresponding amount of payment required to activate the voucher can be substantially less than the redemption value of the voucher. For example, if a voucher is redeemable for any snack up to $1.00, then the amount of payment required to activate the voucher may be, e.g., $0.20. Accordingly, the gift giver (or other party paying the amount of payment required) would pay only 20% of the redemption value of the voucher.

Redemption Monitoring

A gift giver (and/or another) may monitor the redemption of a voucher. For example, a web site may allow a voucher identifier to be input, and in turn display whether the corresponding gift(s) of that voucher have been redeemed. The web site may merely display, e.g., whether or not the voucher has been redeemed for all corresponding gifts. Alternatively, the web site may provide more detailed information, e.g., number of corresponding gifts remaining to be redeemed, actual product(s) that the voucher was redeemed for, date and time of redemption(s), location of the vending machine where the redemption(s) occurred, expiration date(s) of the voucher.

Refilling Vouchers

In an embodiment, a gift giver (or another, such as a gift recipient) may “refill” a voucher such that the recipient may redeem more corresponding gifts by presenting the same voucher identifier. Ideally, but not necessarily, the voucher may be refilled only after the recipient has redeemed all the corresponding gifts of the voucher (i.e. after the voucher cannot be redeemed for further gifts).

In an embodiment, the gift giver (or another, such as a gift recipient) refills the voucher (e.g., by completing another activation process) by adding to the voucher the same corresponding gifts as when the voucher was first activated. Alternatively, the voucher may be refilled with any corresponding product(s), which are presented to the gift giver and/or selected by the gift giver as described herein.

Such ‘re-filling’ may be performed via the same interface or web site used in redemption monitoring.

Vouchers with Multiple Voucher Identifiers

In an embodiment, a gift voucher includes more than one voucher identifier, each associated with a different corresponding gift of the voucher, and each being separately redeemable. For example, a gift voucher bearing the text “One Snickers® bar and One Milky Wayφ bar” may include two voucher identifiers, one that is associated with the Snickers® bar, and one that is associated with the Milky Way® bar. In this manner, the recipient may redeem the Snickers® bar in one transaction and the Milky Way® bar in another.

In embodiments where a voucher includes a plurality of voucher identifiers, the redemption of voucher identifiers may be exclusionary (i.e., not all of the voucher identifiers may be redeemed).

For example, a gift voucher can comprise a first voucher identifier that is valid during a first period of time, and a second voucher identifier that is valid during a second period of time. Entry of one of the voucher identifiers would have to occur during the corresponding period of time that voucher identifier is valid. Such an embodiment may be advantageously used to promote redemption during certain times (e.g., times of relatively low demand) by offering relatively higher value products during those times.

In another embodiment, one or more of the voucher identifiers may be associated with an indeterminate value. Thus, a gift giver may be offered the opportunity to purchase a gift voucher of indeterminate value (e.g., “Mystery Gift Certificate—Good for between $0.75 and $2 of credit!”) Once activated, a gift voucher is output and includes the text: “Enter one of these three codes to redeem your gift—up to $2 in value! 1) 1034584, 2) 1034059, 3) 1034927.” Each of the three codes can represent a voucher identifier, and each is associated with a corresponding gift (e.g., credit amounts of $0.75, $1 and $2 respectively). The recipient may then enter one of the codes (i.e., voucher identifiers), and be provided with the corresponding gift that corresponds to that entered code.

In an embodiment, a gift voucher comprises a first voucher identifier that is valid at a first vending machine, and a second voucher identifier that is valid at a second vending machine. Entry of one of the voucher identifiers would have to occur at the corresponding vending machine that voucher identifier is valid for. Such an embodiment may be advantageously used to promote redemption at certain vending machine (e.g., vending machines of relatively low demand) by offering higher value products at those vending machines.

Gaming Device Vouchers

In an embodiment, rather than a vending machine, one or more gaming devices (e.g., slot machines, video poker machines, video blackjack machines, keno machines) may be used to offer, dispense, activate, and/or redeem vouchers.

Many gaming devices include or are in communication with a peripheral device (a “ticket-in ticket-out” device) that accepts “cashless gaming” tickets, which are paper slips encoded with indicia that indicate a value (e.g., an amount in U.S. currency) for which the ticket may be redeemed. For example, a ticket worth $5.10 may be inserted into a slot reader at a slot machine. In response, the slot machine would acct the ticket as payment of $5.10, and increase accordingly the balance of the slot machine that is available for wagering. When a player requests to cash out (e.g., by pressing a “Cash Out” button), the balance of the gaming device may be dispensed in the form of a ticket redeemable for the amount of the balance.

In an embodiment, when a player hits the “cash out” button, the gaming device displays to the player an offer to divert a portion (or all) of the cashed-out amount to a voucher. The voucher, in turn, is printed and dispensed (a separate cashless gaming receipt for the remaining cashed-out amount, if any, may be output as well). The amount required to activate the voucher may be less than the redemption value of the voucher. For example, the amount required to activate the voucher may be a fixed portion of the redemption value of the voucher (e.g., $10 diverted to the voucher would yield a voucher redeemable for a $20 gift certificate). Other types of gifts could include (i) credits redeemable at a gaming device (e.g., at any gaming device in a casino), (ii) credits redeemable for game “sessions” at a gaming device (e.g., play for a fixed amount of time, play for affixed amount of spins/hands/turns), (iii) room benefits such as discounts on hotel accommodations, (iv) food benefits, such as credit applicable to a restaurant bill.

In another example, the gaming device may output (to a player) an inactive voucher from the “ticket-in ticket-out” device. The player could in turn activate the certificate via the gaming device, via a kiosk, via a casino desk, or in any other manner desirable.

Various “triggering events” include (i) a player achieving winnings over a predetermined amount (e.g., which may be marketed as a “share the luck” gift), (ii) a player attaining a certain outcome (e.g., attaining three cherries at a slot machine), (iii) a player playing at a gaming device at certain times of day.

1. A method comprising:
receiving a payment for a first product at a vending machine;
dispensing the first product from the vending machine after the step of
receiving the payment at the vending machine;
outputting, from the vending machine, a paper which bears indicia
representing a series of alphanumeric characters,
in which the step of outputting is performed substantially simultaneously with the step of dispensing,
in which the series of alphanumeric characters corresponds to a database record denoting an inactive voucher;
after the step of outputting, receiving a request to activate the voucher;
after the step of outputting, receiving a payment at the vending machine;
determining, based on the series of alphanumeric characters, an amount of payment;
receiving at least the amount of payment;
activating the voucher by modifying the database record to denote an active voucher;
after the step of activating the voucher, receiving a request to redeem the voucher,
in which the step of receiving a request to redeem the voucher includes receiving the series of alphanumeric characters;
determining a gift that corresponds to the voucher after the step of receiving a request to redeem the voucher; and
providing the gift via the vending machine.

2. The method of claim 1, in which the step of outputting, from the vending machine, a paper which bears indicia representing a series of alphanumeric characters comprises:
commanding a printer to print the indicia representing a series of alphanumeric characters on the paper.

3. The method of claim 2, further comprising after the step of commanding a printer to print, ejecting the paper from the vending machine.

4. The method of claim 1, in which the step of providing the gift via the vending machine comprises:
dispensing a second product from the vending machine without receiving a retail price of the second product.

5. The method of claim 4, further comprising:
receiving an indication of the second product via an input device of the vending machine before the step of dispensing the second product; and
determining that the second product corresponds to the voucher before the step of dispensing the second product.

6. The method of claim 1, in which the step of providing the gift via the vending machine comprises: I
increasing an amount of funds that are available to pay for a purchase of a product from the vending machine.

7. The method of claim 1, in which the step of activating the voucher by modifying the database record to denote an active voucher comprises:
outputting, from the vending machine, a second paper which bears indicia representing the series of alphanumeric characters.

8. The method of claim 1, in which the indicia representing a series of alphanumeric characters comprises:
a barcode representing the series of alphanumeric characters.

9. The method of claim 1, in which the indicia representing a series of alphanumeric characters comprises:
a printed series of alphanumeric characters.

10. The method of claim 1, further comprising receiving a message before receiving the request to redeem the voucher.

11. The method of claim 10, further comprising:
printing the message on the paper.

12. The method of claim 10, in which the step of providing the gift via the vending machine comprises:
outputting the message.

13. The method of claim 10, in which the step of receiving the message before receiving the request to redeem the voucher comprises:
receiving a name;
and in which the step of providing the gift via the vending machine comprises outputting the name.

14. The method of claim 10, in which the step of receiving the message before receiving the request to redeem the voucher comprises:
displaying an indication of a plurality of messages; and
receiving a selection of at least one of the messages.

15. The method of claim 10, in which the step of receiving the message before receiving the request to redeem the voucher comprises:
activating a recording device to record for an interval of time.

16. The method of claim 1, further comprising setting a gift of the voucher before receiving the request to activate the voucher.

17. The method of claim 16, in which setting a gift of the voucher comprises:
setting the gift of the voucher based on a previously-dispensed product.

18. The method of claim 16, in which setting a gift of the voucher comprises:
setting the gift of the voucher based on inventory data of the vending machine.

19. The method of claim 16, in which setting a gift of the voucher comprises:
setting the gift of the voucher based on sales data of the vending machine.

20. The method of claim 1, in which the series of alphanumeric characters consists of a series of from seven alphanumeric characters to sixteen alphanumeric characters.

21. A method comprising:
outputting, from a vending machine, a voucher which includes a voucher identifier,
in which the voucher is inactive;
after the step of outputting, receiving a request to activate the voucher;
after the step of outputting, receiving a payment at the vending machine;
determining, based on the voucher identifier, an amount of payment;
receiving at least the amount of payment;
activating the voucher, thereby yielding an active voucher;
after the step of activating the voucher, receiving a request to redeem the voucher,
determining a gift that corresponds to the voucher; and providing the gift via the vending machine.

22. A method comprising:
retrieving, from a storage device, at least one rule that defines a triggering event;
determining that the triggering event has occurred;
after determining that the triggering event has occurred, outputting from a vending machine a voucher which includes a voucher identifier,
in which the voucher is inactive;
after the step of outputting, receiving a request to activate the voucher;
activating the voucher, thereby yielding an active voucher;
after the step of activating the voucher, receiving a request to redeem the voucher,
determining a gift that corresponds to the voucher; and providing the gift via the vending machine.
